(19) United States
(12) Patent Application Publication
(10) Pub. No.: US 2024/0353698 A1
(43) Pub. Date: Oct. 24, 2024

(54) ELECTRO-OPTIC MODULATOR

(71) Applicant: Keysight Technologies, Inc., Santa Rosa, CA (US)

(72) Inventor: Gregory S. Lee, Mountain View, CA (US)

(21) Appl. No.: 18/438,647

(22) Filed: Feb. 12, 2024

Related U.S. Application Data
(60) Provisional application No. 63/460,535, filed on Apr. 19, 2023.

(51) Int. Cl. G02F 1/035

(52) U.S. Cl. CPC G02F 1/035; G02F 2202/32

(57) ABSTRACT

An electrooptic (EO) phase modulator is described. The EO phase modulator includes: a first photonic bandgap (PBG) metamaterial region suppressing propagation of light having a wavelength of interest; a second PBG metamaterial region suppressing propagation of light having the same wavelength of interest; an EO region disposed between the first and second PBG metamaterial regions and adapted to guide light having the wavelength of interest; a first electrode contacting the first PBG metamaterial region; and a second electrode contacting the second PBG metamaterial region. A magnitude of an electric field across the first and second PBG metamaterial regions is small compared to a magnitude of the electric field across the EO region. An EO intensity modulator including two EO phase modulators is also described.

### CROSS-REFERENCE TO RELATED APPLICATION

The present application claims priority under 35 U.S.C. § 119(e) and under 37 C.F.R. § 1.78(a) to commonly owned U.S. Provisional Application No. 63/460,535 filed on Apr. 19, 2023. The entire disclosure of U.S. Provisional Application No. 63/460,535 is specifically incorporated herein by reference in its entirety.

### BACKGROUND

Comparatively high-bandwidth (>>100 GHz, so-called “sub-terahertz”) electrooptic (EO) modulators are needed for ultra-high-speed radio frequency (RF)-over-fiber (RFoF) digital and analog links. The ultra-high-speed digital links will be enablers for the ever-increasing optical communication data rates. The analog links will allow sub-terahertz test and measurement solutions that are otherwise prohibitive, mainly due to high cable losses of the RF signals.

The most common type of EO modulators is based on the linear electrooptic or Pockels effect. These comparatively high-bandwidth EO modulators must be driven at the modulation input. This typically requires powerful driver amplifiers. However, high-voltage, high-frequency (sub-terahertz) driver amplifiers are difficult to come by. The drive voltage for this family is typically characterized by the so-called π voltage or V_{π}, which is the drive voltage required to change the output optical phase of a phase modulator or else the differential phase between the two optical arms of a Mach-Zehnder modulator (MZM) by π radians. Due to effects such as RF loss and RC (resistor-capacitor) time constant or RF-optical wave velocity mismatch, V_{π} generally increases with RF frequency.

In many applications, it is desired that V_{π} at the highest frequency of operational interest be no greater than −1.5 V. While known devices may allow a comparatively low π-voltage, this has not been achieved at sub-terahertz RF frequencies without unacceptable optical insertion loss. Rather, to combat the optical insertion loss, amplifiers including rare-earth-doped fiber amplifiers (e.g., erbium-doped fiber amplifiers (EDFA's)) are required. As is known, these amplifiers are prohibitively expensive, and therefore are not a practical option.

What is needed, therefore, is an EO phase modulator, or an EO intensity modulator overcomes at least the noted shortcomings of current optical modulators described above.

### BRIEF DESCRIPTION OF THE DRAWINGS

The example embodiments are best understood from the following detailed description when read with the accompanying drawing figures. It is emphasized that the various features are not necessarily drawn to scale. In fact, the dimensions may be arbitrarily increased or decreased for clarity of discussion. Wherever applicable and practical, like reference numerals refer to like elements.

FIG. 1 is a top view of an EO phase modulator according to a representative embodiment.

FIG. 2 is a cross-sectional view of an EO phase modulator according to a representative embodiment.

FIG. 3 is a cross-sectional view of an EO phase modulator according to a representative embodiment.

FIG. 4 is a top view of an EO phase modulator according to a representative embodiment.

FIG. 5 is a top view an EO intensity modulator according to a representative embodiment.

### DETAILED DESCRIPTION

In the following detailed description, for purposes of explanation and not limitation, representative embodiments disclosing specific details are set forth in order to provide a thorough understanding of an embodiment according to the present teachings. Descriptions of known systems, devices, materials, methods of operation and methods of manufacture may be omitted so as to avoid obscuring the description of the representative embodiments. Nonetheless, systems, devices, materials and methods that are within the purview of one of ordinary skill in the art are within the scope of the present teachings and may be used in accordance with the representative embodiments. It is to be understood that the terminology used herein is for purposes of describing particular embodiments only and is not intended to be limiting. The defined terms are in addition to the technical and scientific meanings of the defined terms as commonly understood and accepted in the technical field of the present teachings.

It will be understood that, although the terms first, second, third etc. may be used herein to describe various elements or components, these elements or components should not be limited by these terms. These terms are only used to distinguish one element or component from another element or component. Thus, a first element or component discussed below could be termed a second element or component without departing from the teachings of the present disclosure.

The terminology used herein is for purposes of describing particular embodiments only and is not intended to be limiting. As used in the specification and appended claims, the singular forms of terms “a,” “an” and “the” are intended to include both singular and plural forms, unless the context clearly dictates otherwise. As such, as used herein and unless clearly described as a single device, the term “a device” means “one or more devices,” and the term “the device” means “one or more devices,”

Additionally, the terms “comprises,” and/or “comprising,” and/or similar terms when used in this specification, specify the presence of stated features, elements, and/or components, but do not preclude the presence or addition of one or more other features, elements, components, and/or groups thereof. As used herein, the term “and/or” includes any and all combinations of one or more of the associated listed items.

Unless otherwise noted, when an element or component is said to be “connected to,” “coupled to,” or “adjacent to” another element or component, it will be understood that the element or component can be directly connected or coupled to the other element or component, or intervening elements or components may be present. That is, these and similar terms encompass cases where one or more intermediate elements or components may be employed to connect two elements or components. However, when an element or component is said to be “directly connected” to another element or component, this encompasses only cases where the two elements or components are connected to each other without any intermediate or intervening elements or components.

As used in the specification and appended claims, the terms “a”, “an” and “the” include both singular and plural referents, unless the context clearly dictates otherwise. Thus, for example, “a device” includes one device and plural devices. As used in the specification and appended claims, and in addition to their ordinary meanings, the terms “substantial” or “substantially” mean to within acceptable limits or degree. As used in the specification and the appended claims and in addition to its ordinary meaning, the term “approximately” means to within an acceptable limit or amount to one having ordinary skill in the art. For example, “substantially” or “approximately” the same means that one of ordinary skill in the art would consider the items being compared to be the same.

The present disclosure, through one or more of its various aspects, embodiments and/or specific features or sub-components, is thus intended to bring out one or more of the advantages as specifically noted below. For purposes of explanation and not limitation, example embodiments disclosing specific details are set forth in order to provide a thorough understanding of an embodiment according to the present teachings. However, other embodiments consistent with the present disclosure that depart from specific details disclosed herein remain within the scope of the appended claims. Moreover, descriptions of well-known apparatuses and methods may be omitted so as to not obscure the description of the example embodiments. Such methods and apparatuses are within the scope of the present disclosure.

In a general sense, the present teachings relate to an EO modulator structure that provides optical and electrical confinement resulting in a device that has a comparatively low V_{π}, a comparatively high optical bandwidth, and a low optical insertion loss. As described more fully below, these characteristics are achieved through the use of a photonic bandgap (PBG) metamaterial region disposed adjacent to an EO region and between the electrodes that apply the modulation voltage. At optical wavelengths of interest, light is highly confined to the EO region, and suppressed in the PBG layer. This results in improved optical confinement of the optical signal and reduced loss of optical power, ultimately providing a low optical insertion loss. As such, further amplification of the modulated optical signal (e.g., by an expensive EDFA) that is undesirably necessitated by known devices is not required.

The PBG metamaterial region comprises openings in a material having a comparatively high relative permittivity εᵣ at a modulation frequency. These openings may be filled with a photonic crystal (PhC) material, or a dielectric material or air. The comparatively high dielectric material region acts somewhat as an AC short circuit. Specifically, and as described more fully below, applied modulation signals experience a comparatively low voltage drop across the high dielectric material region, and a comparatively high voltage drop across the EO region. Because the majority of the voltage drop from the modulation signal occurs across the EO region, V_{π} is comparatively large, and the need for a high bandwidth, high power amplifier that plagues known devices is significantly reduced if not eliminated.

In accordance with one aspect of the present teachings, an electrooptic (EO) phase modulator is described. The EO phase modulator comprises: a first photonic bandgap (PBG) metamaterial region suppressing propagation of light having a wavelength of interest; a second PBG metamaterial region suppressing propagation of light having the same wavelength of interest; an EO region disposed between the first and second PBG metamaterial regions and adapted to guide light having the wavelength of interest; a first electrode contacting the first PBG metamaterial region; and a second electrode contacting the second PBG metamaterial region. A magnitude of an electric field across the first and second PBG metamaterial regions is small compared to a magnitude of the electric field across the EO region.

In accordance with another aspect of the present teachings an electrooptic (EO) intensity modulator is described. The electrooptic (EO) intensity modulator comprises: a first EO phase modulator, comprising: a first photonic bandgap (PBG) metamaterial region suppressing propagation of light having a wavelength of interest; a second PBG metamaterial region suppressing propagation of light having the same wavelength of interest; a first EO region disposed between the first and second PBG metamaterial regions and adapted to guide light having the wavelength of interest; a first electrode contacting the first PBG; and a second electrode contacting the second PBG, wherein a first magnitude of a first electric field across the first and second PBG metamaterial regions is small compared to a magnitude of the first electric field across the first EO region; and a second EO phase modulator, comprising: a third photonic bandgap (PBG) metamaterial region suppressing propagation of light having a wavelength of interest; a fourth PBG metamaterial region suppressing propagation of light having the same wavelength of interest; a second EO region disposed between the third and fourth PBG metamaterial regions and adapted to guide light having the wavelength of interest, wherein the electrode contacts the third metamaterial region; and a third electrode contacting the fourth PBG metamaterial region, wherein a second magnitude of a second electric field across the third and fourth PBG metamaterial regions is small compared to a magnitude of the second electric field across the second EO region. As such, in accordance with certain representative embodiments, input light is split to enter the first and second EO phase modulators resulting in intensity-modulating interference upon exiting the first and second EO phase modulators.

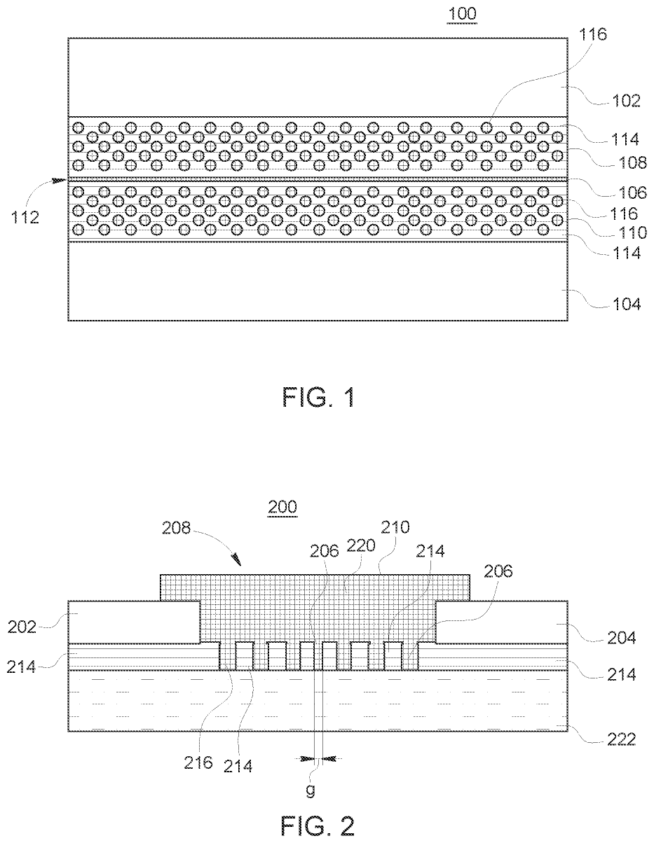

FIG. 1 is a top view of an EO phase modulator 100 according to a representative embodiment. The EO phase modulator 100 comprises a first electrode 102 (e.g., a positive electrode), a second electrode 104 (e.g., a negative electrode), an EO region 106, a first PBG metamaterial region 108 and a second PBG metamaterial region 110. As described more fully below, light 112 is substantially confined to the EO region 106. In accordance with the present teachings described more fully below, the substantial confinement of the light in the EO region 106 results not from conductivity of the first and second electrodes, but rather from the honeycomb lattice and high/low refractive index contrast of the opening/high dielectric coefficient layer in the first and second PBG metamaterial regions 108, 110. This substantially prevents the evanescent optical tail at the interfaces of the EO region 106 and the first and second PBG metamaterial regions 108, 110 from reaching the first and second electrodes 102, 104, where optical losses may occur. As such, the optical loss is comparatively low. Moreover, and as described more fully below, the first and second PBG metamaterial regions 108, 110 the voltage drop between the first and second electrodes 102, 104 across the first and second PBG metamaterial regions 108, 110 is small compared to the voltage drop across the EO region. As noted above, this results in lower V_{π}.

The electrical signals function as the modulation voltage across the EO region 106. The EO region 106 comprises a material that achieves Pockels activity and thus a linear electro-optic effect. In accordance with a representative embodiment, the EO material may be an organic EO (OEO) material and thereby comprises polymers. This is merely illustrative, and other EO materials are contemplated for the EO region 106. Notably, the DC resistivity of the OEO material used for the EO region 106 is high compared to the DC resistivity of the first and second PBG metamaterial regions 108, 110. Beneficially, this facilitates poling of the polymer material needed to achieve comparatively high Pockels activity. The first and second PBG metamaterial regions 108, 110 each comprise a high dielectric constant material 114 comprising openings 116 therein. Illustratively, the first and second PBG metamaterial regions 108, 110 comprise a honeycomb structure, although this is not essential. More generally, the openings 116 in the first and second PBG metamaterial regions 108, 110 have a width or diameter that is small compared to the wavelength of the modulation frequency of the signals across the first and second electrodes 102, 104. Just by way of illustration, the diameter/width of the openings 116 is illustratively in the range of approximately 0.01 m and 0.5 m for commonly used optical communication wavelengths. Notably, while the openings 116 are shown having substantially the same width/diameter, this is not necessary, and openings 116 in the high dielectric constant material 114 having different widths/diameters are contemplated. Moreover, the present teachings contemplate various other variants to the structure of the first and second PBG metamaterial regions 108, 110. These include but are not limited to different lattice geometries, such as a so-called Manhattan-like geometry and more complicated unit cells. Illustratively, the various shapes and geometries, and among other benefits, allow the designer to provide a wider forbidden wavelength span in the first and second PBG metamaterial regions 108, 110. More generally, the impact of the first and second PBG metamaterial regions 108, 110 results from a combination of the geometry (e.g., honeycomb, hole sizes, etc.) and the optical refractive index contrast between the openings 116 and the high dielectric constant material 114. Just by way of illustration, the ratio of the optical indices of refraction of the material in the openings and the high dielectric constant material 114 is ≤1.25:1. It is further noted that while it is normally the case that a material having a comparatively low optical index of refraction has a comparatively low relative permittivity Fr and a material having a comparatively high optical index of refraction has a comparatively high relative permittivity εᵣ, this is not necessarily the case.

In a representative embodiment, the high dielectric constant material 114 of the first and second PBG metamaterial regions 108, 110 has a relative permittivity Fr that is greater than 50 and can be as high as 10⁵. Illustrative materials contemplated for the high dielectric constant material 114 of the first and second PBG metamaterial regions 108, 110 include titanium dioxide (TiO₂), BaTiO₃ (BTO), titanates, zirconates, vanadates, niobates, tantalates, chromates, and tungstates having a perovskite or a layered perovskite crystal structure. Other materials contemplated for the high dielectric constant material 114 include, but are not limited to SrTiO₃ (STO), (Ba,Sr)TiO₃ (BST), PbTiO₃, Pb(Zr,Ti)O₃ (PZT), TiO₂, as well as various other materials having a with ultra-high dielectric constant. Many perovskite and layered perovskite solids fit the bill of (nearly) ferroelectric, high-dielectric-constant material.

Beneficially, and as will become clearer as the present description continues, the comparatively large dielectric constant of high dielectric constant material 114 reduces the voltage drop across the first and second PBG metamaterial regions 108, 110, resulting in more efficient modulation in the EO region, reducing both V_{π} and the need for amplification of the modulated optical signal such as by a EDFA, for example.

By contrast, the openings 116 comprise a material having a comparatively low dielectric constant (low relative permittivity εᵣ). Just by way of example, the comparatively low Fr is in a range of approximately 1 to approximately 10. As described more fully below, one attractive option for the material disposed in the openings 116 is the same material used for the EO region 106, such as OEO. This material provides a comparatively low relative permittivity Fr as desired to form the PBG region and its selection facilitates fabrication of the EO phase modulator 100. Alternatively, other comparatively low relative permittivity εᵣ materials including various oxides (e.g., SiO₂) or air can be used in the openings 116.

As noted above, the combination of each of the first and second PBG metamaterial regions 108, 110 provide a photonic bandgap that suppresses light at the desired wavelength. At the same time, because the openings 116 comprising the comparatively low relative permittivity Fr material are small compared to the wavelength of the modulation signal (e.g., RF) across the first and second electrodes 102, 104, the effective dielectric constant of the first and second PBG metamaterial regions 108, 110 is comparatively high. Stated somewhat differently, the first and second PBG metamaterial regions 108, 110, having openings 116 with comparatively a low relative permittivity Fr disposed in the high dielectric constant material 114 having a comparatively high a relative permittivity εᵣ, have an effective relative permittivity Fr seen by the modulation signal across the first and second electrodes 102, 104 that is comparatively high. Because the divergence of the displacement vector (∇·D) is equal to the free charge (ρ_{f}), which is zero in this case and is unchanged across the first and second PBG metamaterial regions 108, 110 and the EO region 106, the magnitude of the electric field across the first and second PBG metamaterial regions 108 and 110 is much smaller than the magnitude of the electric field across the EO region 106, which has a comparatively low relative permittivity εᵣ, where the magnitude of the electric field is desirably high. Specifically, the transverse displacement vector from Maxwell's Equations is continuous (D_{T}=ε_{T}E_{T}) is continuous, where the subscript T denotes transverse component and E is the electric field, and since the transverse effective dielectric constant ε_{T} is much larger in the first and second PBG metamaterial regions 108, 110 than the transverse dielectric constant ε_{T} in the material of the EO region 106, and the line integral of the alternating electric field (E_{ac}) across the first and second electrodes 102, 104 is the AC voltage, the majority of the voltage drops across the EO region 106. Beneficially, therefore, the voltage drop of the modulation signal across the EO region 106 is high compared to its drop across the first and second PBG metamaterial regions 108, 110, and the efficiency of the electro-optic effect is beneficially high. Furthermore, and as alluded to above, because the voltage drop across the first and second PBG metamaterial regions 108, 110 EO efficiency improves to the point that a comparatively low V_{π} results, thereby reducing the need for large bandwidth amplifiers, which, as noted above, are undesirably expensive.

As noted above, the first and second PBG metamaterial regions 108, 110 provide optical confinement by providing an optical bandgap that spans the wavelength(s) of interest, so that light propagation is confined to the EO region 106. As such, the optical loss is comparatively low. This in turn, reduces if not eliminates the need for optical amplification by a costly EDFA for example that is required of known EO modulators. Accordingly, high effective relative permittivity εᵣ/low relative permittivity εᵣ/high effective relative permittivity εᵣ provided by the first PBG metamaterial region 108/EO region 106/second PBG metamaterial region 110 provides a waveguide structure. As noted above, the substantial confinement of the light in the EO region 106 results not from conductivity of the first and second electrodes 102, 104, but from the honeycomb lattice and high/low refractive index contrast of opening 116/high dielectric constant material 114 in the first and second PBG metamaterial regions 108, 110. This substantially prevents the evanescent optical tail at the interfaces of the EO region 106 and the first and second PBG metamaterial regions 108, 110 from reaching the first and second electrodes 102, 104, where optical losses may occur. As such, the optical loss is comparatively low. Moreover, and as described more fully below, the majority of the voltage drop between the first and second electrodes 102, 104 occurs across the EO region 106 rather than across the first and second PBG metamaterial regions 108, 110. As noted above, this results in reduced optical insertion loss, reduces if not eliminates the need for optical amplification of the input optical signal to and the output optical signal from the EO region 106, and results in a reduced V_{π}.

FIG. 2 is a cross-sectional view of an EO phase modulator 200 according to a representative embodiment. Various aspects and details of the EO phase modulator 200 are common to those described above in connection with the description of the representative embodiments of FIG. 1. These common aspects and details may not be repeated to avoid obscuring the presently described representative embodiments.

The EO phase modulator 200 comprises a first electrode 202 (e.g., a positive electrode), a second electrode 204 (e.g., a negative electrode), an EO region 206, a first PBG metamaterial region 208 and a second PBG metamaterial region 210. Light (not shown in FIG. 2) travels into/out of the plane of the page and is substantially confined to the EO region 206. Moreover, and as described above, electrical signals from the first and second electrodes 202, 204 used in signal modulation by the Pockel's effect are also substantially confined to the EO region 206. As such, the optical signal from the light does not have a significant evanescent tail in the first and second PBG metamaterial regions 208, 210, and the voltage drop between the first and second electrodes 202, 204 across the first and second PBG metamaterial regions 208, 210 is small compared to the voltage drop across the EO region. As noted above, this results in reduced optical insertion loss, and reduced electrical power loss in the first and second PBG metamaterial regions 208, 210.

The electrical signals from the first and second electrodes 202, 204 function as the modulation voltage across the EO region 206. The EO region 206 comprises a material 220 that achieves Pockels activity and thus a linear electro-optic effect. In accordance with a representative embodiment, the EO material may be an organic EO (OEO) material and thereby comprises polymers. This is merely illustrative, and other EO materials are contemplated for the EO region 206. Notably, the DC resistivity of the OEO material used for the EO region 206 is high compared to the DC resistivity of the first and second PBG metamaterial regions 208, 210. Beneficially, this facilitates poling of the polymer material needed to achieve comparatively high Pockels activity.

The first and second PBG metamaterial regions 208, 210 each comprise a high dielectric constant material 214 comprising openings 216 therein. Illustratively, the first and second PBG metamaterial regions 208, 210 comprise a honeycomb structure, although this is not essential. More generally, the openings 216 in the first and second PBG metamaterial regions 208, 210 have a width or diameter that is small compared to the wavelength of the modulation frequency of the signals across the first and second electrodes 202, 204. Notably, while the openings 216 are shown having substantially the same width/diameter, this is not necessary, and openings 216 in the high dielectric constant material 214 having different widths/diameters are contemplated.

The EO phase modulator 200 also comprises a substrate 222. The substrate 222 comprises a commonly used material suitable for photonics applications. Just by way of illustration, the substrate 222 comprises comparatively high-resistivity silicon (Si) or quartz or other glass materials commonly used in the photonics industry.

As alluded to above, the material 220 used to attain the linear EO effect in EO region 206 comprises a low relative permittivity εᵣ compared to the effective relative permittivity εᵣ of the first and second PBG metamaterial regions 208, 210. Illustratively, the material 220 comprises a suitable OEO as noted above, which facilitates fabrication/processing of the EO phase modulator 200. Just by way of illustration, after forming the openings 216 in the high dielectric constant material 214, a suitable OEO polymer may be spun on and planarized using a known fabrication technique. The OEO material not only fills the EO region 206 as shown, but also fills the openings 216 in the high dielectric constant material 214, and thereby provides the first and second PBG metamaterial regions 208, 210 on either side of the EO region 206.

It is emphasized that the use of OEO material to fill the openings 216 is merely illustrative, and other materials are contemplated for filling the openings 216. As noted above, for example, the openings may be filled with another suitable dielectric material having a low relative permittivity εᵣ compared to the relative permittivity εᵣ of the first and second PBG metamaterial regions 208, 210. Just by way of illustration, the openings 216 may be filled with SiO₂ formed by a known semiconductor processing technique such as plasma-enhanced chemical vapor deposition (PECVD).

As described above, having the EO region 206 disposed between first and second PBG metamaterial regions 208, 210 fosters optical confinement of light substantially to the EO region 206, and confinement of the modulation signals from the first and second electrodes 202, 204 to the EO region as well. As described more fully above, this structure beneficially affords a comparatively low V_{π}, and beneficially reduces or eliminates the need for a comparatively high bandwidth amplifier required of certain known EO modulator structures. Moreover, first PBG metamaterial region 208/EO region 206/second PBG metamaterial region 210 provides a waveguide structure as described more fully above, and reduces if not eliminates the need for optical amplification of the input optical signal to and the output optical signal from the EO region 106.

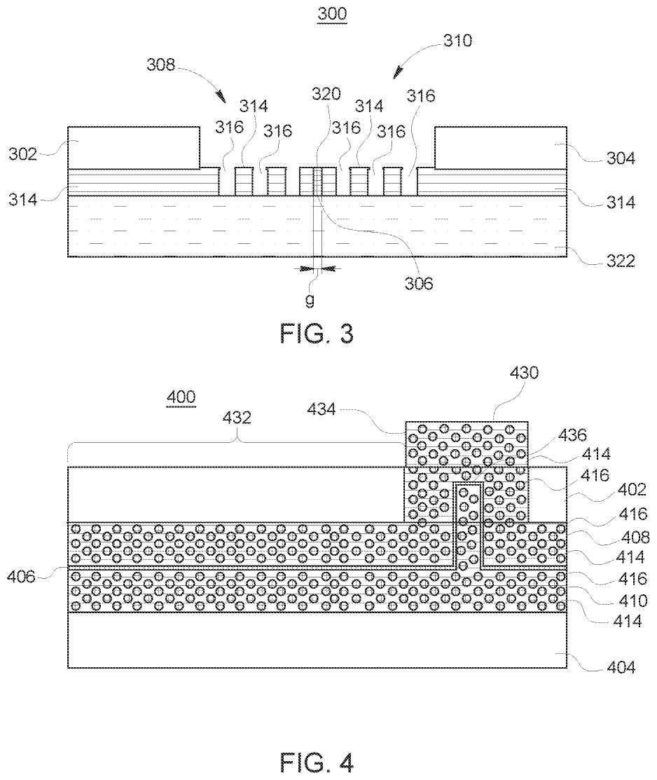

FIG. 3 is a cross-sectional view of an EO phase modulator 300 according to a representative embodiment. Various aspects and details of the EO phase modulator 300 are common to those described above in connection with the description of the representative embodiments of FIGS. 1 and 2. These common aspects and details may not be repeated to avoid obscuring the presently described representative embodiments.

The EO phase modulator 300 comprises a first electrode 302 (e.g., a positive electrode), a second electrode 304 (e.g., a negative electrode), an EO region 306, a first PBG metamaterial region 308 and a second PBG metamaterial region 310. Light (not shown in FIG. 2) travels into/out of the plane of the page and is substantially confined to the EO region 306. Moreover, and as described above, electrical signals from the first and second electrodes 302, 304 used in signal modulation by the Pockel's effect are also substantially confined to the EO region 306. As such, the optical signal from the light does not have a significant evanescent tail in the first and second PBG metamaterial regions 308, 310, and the voltage drop between the first and second electrodes 302, 304 across the first and second PBG metamaterial regions 308, 310 is small compared to the voltage drop across the EO region. As noted above, this results in reduced optical insertion loss, and reduced electrical power loss in the first and second PBG metamaterial regions 308, 310.

The electrical signals from the first and second electrodes 302, 304 function as the modulation voltage across the EO region 306. The EO region 306 comprises a material 320 that achieves Pockels activity and thus a linear electro-optic effect. In accordance with a representative embodiment, the EO material may be an organic EO (OEO) material and thereby comprises polymers. This is merely illustrative, and other EO materials are contemplated for the EO region 306. Notably, the DC resistivity of the OEO material used for the EO region 306 is high compared to the DC resistivity of the first and second PBG metamaterial regions 308, 310. Beneficially, this facilitates poling of the polymer material needed to achieve comparatively high Pockels activity.

The first and second PBG metamaterial regions 308, 310 each comprise a high dielectric constant material 314 comprising openings 316 therein. Illustratively, the first and second PBG metamaterial regions 308, 310 comprise a honeycomb structure, although this is not essential. More generally, the openings 316 in the first and second PBG metamaterial regions 308, 310 have a width or diameter that is small compared to the wavelength of the modulation frequency of the signals across the first and second electrodes 302, 304. Notably, while the openings 316 are shown have substantially the same width/diameter, this is not necessary, and openings 316 in the high dielectric constant material 314 having different widths/diameters are contemplated.

The EO phase modulator 300 also comprises a substrate 322. The substrate 322 comprises a commonly used material suitable for photonics applications. Just by way of illustration, the substrate 322 comprises comparatively high-resistivity silicon (Si) or quartz or other glass materials commonly used in the photonics industry.

As alluded to above, the material 320 used to attain the linear EO effect in EO region 306 comprises a low relative permittivity εᵣ compared to the effective relative permittivity εᵣ of the first and second PBG metamaterial regions 308, 310. Illustratively, the material 320 comprises a suitable OEO as noted above, which facilitates fabrication/processing of the EO phase modulator 300.

As described above, rather than filling the openings 316 with either OEO material or other suitable dielectric one or more of the openings 316 can remain unfilled, with air providing the dielectric material having a low relative permittivity Fr compared to the relative permittivity Fr of the high dielectric constant material 314.

As described above, having the EO region 306 disposed between first and second PBG metamaterial regions 308, 310 fosters optical confinement of light substantially to the EO region 306, and confinement of the modulation signals from the first and second electrodes 302, 304 to the EO region as well. As described more fully above, this structure beneficially affords a comparatively low V_{π}, and beneficially reduces or eliminates the need for a comparatively high bandwidth amplifier required of certain known EO modulator structures. Moreover, the first PBG metamaterial region 308/EO region 306/second PBG metamaterial region 310 provides a waveguide structure as described more fully above, and reduces if not eliminates the need for optical amplification of the input optical signal to and the output optical signal from the EO region 106. For purposes of description of various aspects of the representative embodiments described in connection with FIGS. 1-3 above, certain parameters are provided below to illustrate a typical length L, which comprises a total active length of the EO phase modulators 100, 200, 300, necessary to achieve a low-frequency V_{π} of 1 V of 1 GHz or lower. For example, the EO intensity modulator 500 represents one cell that is repeated to build up the active length L. In practice, one may measure the low-frequency V_{π} at approximately kHz frequencies and many modulators retain roughly the same V_{π} to approximately 1 GHz. Notably, however, as f>>1 GHz, the V_{π}, of many modulators (undesirably) increases substantially.

Suppose the width (“g” in FIGS. 2 and 3) of the EO regions 106, 206, 306 is g=180 nm. Also suppose an illustrative OEO figure of merit n³r₃₃=2300 pm/V, n is the optical index of refraction and r₃₃ is the Pockels coefficient along the poling axis after poling has been performed. Furthermore, assume an EO overlap efficiency η=80%. Then a standard calculation of the V_{π}L product of an Mach Zehnder Modulator (MZM) (2-arm interferometric modulator) is:

$${V}_{π} L = g * λ / ( 2 η * {n}^{3} {r}_{33} ) \qquad Eqn . ( 1 )$$

where k is the optical carrier wavelength. For the popular optical communications wavelength λ=1550 nm, Eqn. (1) gives us V_{π}L=76 V-μm. This means that a low-frequency V_{π} of 1 V can be achieved in a length L=76 um.

Electromagnetic simulation suggests this amount of active length results in a capacitance C=27.4 fF. If the driver amplifier has an output impedance of 50Ω, then the RC time constant is 1.37 ps and the 3-dB bandwidth would be 1/(2πGRC)=116 GHz. While this represents a comparatively wide bandwidth, even higher bandwidths are contemplated while maintaining a low V_{π}? The standard way of overcoming an RC limit is to propagate the RF collinearly with the optical wave in a traveling-wave fashion, matching the RF wave velocity to the optical group velocity. Equivalently, one usually refers to matching the effective index n_{eff,RF} of the RF wave to the group velocity index n_{g} of the optical wave. Larger index means a slower wave.

Geometry and materials leading to the V_{π}L=76 V-um estimate suggest n_{eff,RF}=3.46. A typical OEO material like refractive index n˜1.85 at 1550 nm. If optical waveguiding effects are ignored, the following relationship between optical group index and refractive index is realized:

$${n}_{g} = n - λ * dn / d λ \qquad Eqn . ( 2 )$$

For the illustrative OEO material, Eqn. (2) yields n_{g}=2.062. Hence the RF wave would seem to be considerably slower than the optical wave. On the other hand, waveguiding of the light can additionally reduce the optical group velocity. For example, BaTiO3 has a refractive index n˜2.27-2.3 at λ=1550 nm, considerably higher than the OEO refractive index. If the PBG metamaterial region/EO region/PBG metamaterial region combination is designed so that, as λ decreases, more of the optical mode “sneaks” into the BaTiO3 regions immediately adjacent to the gap, then the waveguide-generalized analog of Eqn. (2) predicts that n_{g,WG} will be significantly larger than 2.062.

FIG. 4 is a top view of an EO phase modulator 400 according to a representative embodiment. Various aspects and details of the EO phase modulator 400 are common to those described above in connection with the description of the representative embodiments of FIGS. 1-3. These common aspects and details may not be repeated to avoid obscuring the presently described representative embodiments.

The EO phase modulator 400 comprises a first electrode 402 (e.g., a positive electrode), a second electrode 404 (e.g., a negative electrode), an EO region 406, a first PBG metamaterial region 408 and a second PBG metamaterial region 410. Light (not shown in FIG. 2) travels into/out of the plane of the page and is substantially confined to the EO region 406. Moreover, and as described above, electrical signals from the first and second electrodes 402, 404 used in signal modulation by the Pockel's effect are also substantially confined to the EO region 406. As such, and as noted above, the optical signal from the light is substantially confined to the EO region 406, and the voltage drop between the first and second electrodes 402, 404 across the first and second PBG metamaterial regions 408, 410 is small compared to the voltage drop across the EO region. As noted above, this results in reduced optical insertion loss and reduced V_{π}.

The first and second PBG metamaterial regions 408, 410 each comprise a high dielectric constant material 414 comprising openings 416 therein. Illustratively, the first and second PBG metamaterial regions 408, 410 comprise a honeycomb structure, although this is not essential. More generally, the openings 416 in the first and second PBG metamaterial regions 408, 410 have a width or diameter that is small compared to the wavelength of the modulation frequency of the signals across the first and second electrodes 402, 404. Notably, while the openings 416 are shown have substantially the same width/diameter, this is not necessary, and openings 416 in the high dielectric constant material 414 having different widths/diameters are contemplated.

The EO phase modulator 400 also comprises a so-called passive catch-up section 430 at the end of the active EO modulator section 432. The passive catch-up sections comprise a third PBG metamaterial region 434 having a second EO region 436 disposed therebetween. The second EO region 436 comprises a suitable EO material as EO region 406, as this is merely an extension of EO region 406, but is not modulated by the electrical signal. As such, because of the materials and structure of the third PBG metamaterial region 434 having the second EO region 436, the light remains confined in the second EO region 436. Similarly, the electrical signals from the first and second electrodes 402, 404 also remain confined in the second EO region 436. Because the modulation signal is slow compared to the light guided in EO region 406 and second EO region 436 providing a plurality of passive catch-up sections 430 along the optical path of the EO phase modulator 400. After each active modulator section, light traverses a catch-up section such as passive catch-up section 430 enabling resynchronization of the optical and electrical (modulation) signals. As such, in accordance with this representative embodiment, the EO phase modulator 400 comprising the passive catch-up section 430 allows the electrical (e.g. RF) modulation signal to catch up with the light guided in the EO region 406.

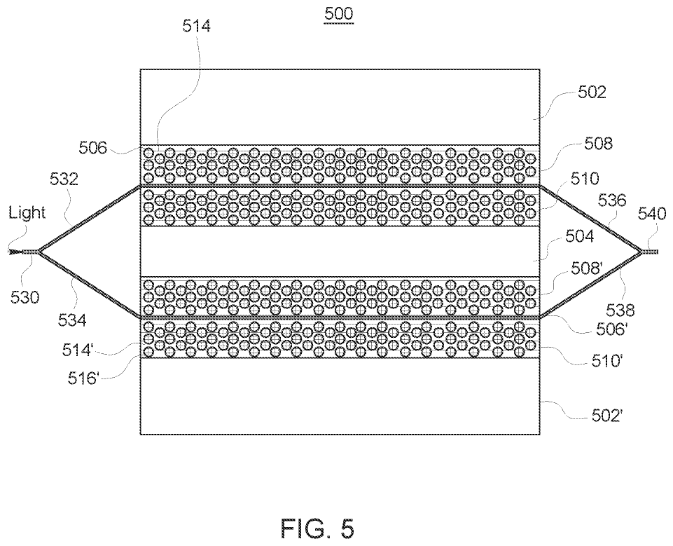

FIG. 5 is a top view of an EO intensity modulator 500 according to a representative embodiment. Various aspects and details of the EO intensity modulator 500 are common to those described above in connection with the description of the representative embodiments of FIGS. 1-43. These common aspects and details may not be repeated to avoid obscuring the presently described representative embodiments.

The EO intensity modulator 500 comprises a first EO modulator comprising a first electrode 502 (e.g., a ground electrode), a second electrode 504 (e.g., a signal electrode), an EO region 406, a first PBG metamaterial region 408 and a second PBG metamaterial region 410. Moreover, and as described above, electrical signals from the first and second electrodes 502, 504 used in signal modulation by the Pockel's effect are also substantially confined to the EO region 506. As such, and as described above, the optical signal from the light is substantially confined to the EO region 506, and the voltage drop between the first and second electrodes 502, 504 across the first and second PBG metamaterial regions 408, 510 is small compared to the voltage drop across the EO region. As noted above, this results in reduced optical insertion loss, reduced electrical power loss in the first and second PBG metamaterial regions 508, 510, and a reduced V_{π}. Notably, V_{π} for a push-pull intensity modulator as shown in FIG. 5 is actually one-half that of a phase modulator because one needs only π/2 phase shift from each arm of the MZM, wherein each arm comprises the first and second EO phase modulators. The EO intensity modulator 500 comprises a second EO phase modulator comprising a first electrode 502′ (e.g., a ground electrode), the second electrode 504 (e.g., a signal electrode), an EO region 506′, a first PBG metamaterial region 508′ and a second PBG metamaterial region 510′.

As described above, electrical signals from the first and second electrodes 502′, 504′ used in signal modulation by the Pockel's effect are also substantially confined to the EO region 506′. As such, the optical signal from the light is substantially confined to the EO region 506′, and the voltage drop between the first and second electrodes 502, 504 across the first and second PBG metamaterial regions 508′, 510′ is small compared to the voltage drop across the EO region. As noted above, this results in reduced optical insertion loss, and reduced electrical power loss in the first and second PBG metamaterial regions 508′, 510′, and a reduced V_{π}. Light is incident on a Y-junction input splitter 530 with a first input signal 532 provided to the first EO phase modulator, and a second input branch 534 provided to the second EO phase modulator as shown. After modulation, a first output branch 536 and a second output branch 538 signal are provided to a Y-junction output combiner 540 to provide the output signal. Notably, the Y-junction input splitter 530 can be constructed similarly to the PBG metamaterial/OEO/PBG metamaterial. Notably, and as will be appreciated from an understanding of the Mach-Zehnder Interferometer (MZI), light in first output branch 536 and second output branch 538 interfere either constructively, destructively, or intermediately, depending on the total phase modulation of first and second EO phase modulators, thus resulting in overall intensity modulation at y-junction output combiner 540.

While the invention has been illustrated and described in detail in the drawings and foregoing description, such illustration and description are to be considered illustrative or exemplary and not restrictive; the invention is not limited to the disclosed embodiments. Other variations to the disclosed embodiments can be understood and effected by those having ordinary skill in the art in practicing the claimed invention, from a study of the drawings, the disclosure, and the appended claims. In the claims, the word “comprising” does not exclude other elements or steps, and the indefinite article “a” or “an” does not exclude a plurality. The mere fact that certain measures are recited in mutually different dependent claims does not indicate that a combination of these measures cannot be used to an advantage.

Aspects and details of the present teachings may be embodied as an apparatus, method or computer program product. Accordingly, aspects and details of the present invention may take the form of an entirely hardware embodiment, an entirely software embodiment (including firmware, resident software, micro-code, etc.) or an embodiment combining software and hardware aspects and details that may all generally be referred to herein as a “circuit,” “module” or “system.” Furthermore, aspects and details of the present invention may take the form of a computer program product embodied in one or more computer readable medium(s) having computer executable code embodied thereon.

While representative embodiments are disclosed herein, one of ordinary skill in the art appreciates that many variations that are in accordance with the present teachings are possible and remain within the scope of the appended claim set. The invention therefore is not to be restricted except within the scope of the appended claims.

I claim:

1. An electrooptic (EO) phase modulator, comprising:
a first photonic bandgap (PBG) metamaterial region suppressing propagation of light having a wavelength of interest;
a second PBG metamaterial region suppressing propagation of light having the same wavelength of interest;
an EO region disposed between the first and second PBG metamaterial regions and adapted to guide light having the wavelength of interest;
a first electrode contacting the first PBG metamaterial region; and
a second electrode contacting the second PBG metamaterial region, wherein a magnitude of an electric field across the first and second PBG metamaterial regions is small compared to a magnitude of the electric field across the EO region.

2. The EO phase modulator of claim 1, wherein the first and second PBG metamaterial regions comprise regions having a comparatively high relative dielectric constant (εᵣ) and regions having a comparatively low Fr, wherein the regions having a comparatively low Fr, and the regions of comparatively high and comparatively low Fr substantially suppress propagation of light having the wavelength of interest.

3. The EO phase modulator of claim 2, wherein a voltage drop at a modulation frequency across the first and second PBG metamaterial regions is in the range of approximately 5% to less than approximately 50% of the voltage applied between the first and second electrodes.

4. The EO phase modulator of claim 2, wherein the comparatively high Fr is in a range of approximately 50 to approximately 10′.

5. The EO phase modulator of claim 1, wherein the comparatively low Fr is in a range of approximately 1 to approximately 10.

6. The EO phase modulator of claim 1, wherein the PBG of the first and second PBG metamaterial regions span a wavelength having an absolute frequency difference less than a highest modulation frequency of interest.

7. The EO phase modulator of claim 1, wherein openings exist in the first and second PBG metamaterial regions.

8. The EO phase modulator of claim 7, wherein a honeycomb structure exists and the openings comprise the EO material.

9. The EO phase modulator of claim 7, wherein the openings comprise one or more of air, silicon dioxide (SiO₂).

10. The EO phase modulator of claim 7, wherein the comparatively high εᵣ material comprises one or more of titanates, zirconates, vanadates, niobates, tantalates, chromates, tungstates having a perovskite or a layered perovskite crystal structure, and titanium oxide (TiO₂).

11. The EO phase modulator of claim 7, wherein a wavelength of a modulating signal between the first and second electrodes is greater than a width of the openings so that the modulating signal is not substantially affected by the openings.

12. The EO phase modulator of claim 1, wherein the first and second electrodes each contact the PBG metamaterial structure layer and are separated from the EO layer by a distance sufficient so an optical mode propagating in the PBG metamaterial layer does not overlap the first and second electrodes.

13. The EO phase modulator of claim 1, wherein an effective dielectric constant at a modulation frequency of the first and second PBG layers is significantly greater than a dielectric constant of the EO material.

14. The EO phase modulator of claim 1, wherein the EO phase modulator comprises a first active section, a second active section and a passive section disposed between the first and second active sections.

15. The EO phase modulator of claim 14, wherein lengths of the first and second active section and the passive section are selected so a Bragg frequency is greater than a highest radio frequency (RF) of interest to substantially prevent Bragg reflection at interfaces of the EO region and the first and second PBG metamaterial regions.

16. An electrooptic (EO) intensity modulator, comprising:
a first EO phase modulator, comprising: a first photonic bandgap (PBG) metamaterial region suppressing propagation of light having a wavelength of interest; a second PBG metamaterial region suppressing propagation of light having the same wavelength of interest; a first EO region disposed between the first and second PBG metamaterial regions and adapted to guide light having the wavelength of interest; a first electrode contacting the first PBG; and a second electrode contacting the second PBG, wherein a first magnitude of a first electric field across the first and second PBG metamaterial regions is small compared to a magnitude of the second electric field across the first EO region; and
a second EO phase modulator, comprising: a third photonic bandgap (PBG) metamaterial region suppressing propagation of light having a wavelength of interest; a fourth PBG metamaterial region suppressing propagation of light having the same wavelength of interest; a second EO region disposed between the third and fourth PBG metamaterial regions and adapted to guide light having the wavelength of interest, wherein the electrode contacts the third metamaterial region; and a third electrode contacting the fourth PBG metamaterial region, wherein a second magnitude of a second electric field across the third and fourth PBG metamaterial regions is small compared to a magnitude of the second electric field across the second EO region, wherein input light is split to enter the first and second EO phase modulators resulting in intensity-modulating interference upon exiting the first and second EO phase modulators.

17. The EO intensity modulator of claim 16, wherein the first, second, third and fourth PBG metamaterial regions each comprise regions having a comparatively high relative dielectric constant (εᵣ) and regions having a comparatively low εᵣ, wherein the regions having a comparatively low Fr, and the regions of comparatively high and comparatively low Fr substantially suppress propagation of light having the wavelength of interest.

18. The EO intensity modulator of claim 17, wherein a first voltage drop at a modulation frequency across the first and second PBG metamaterial regions is in the range of approximately 5% to less than approximately 50% of the voltage applied between the first and second electrodes, and a second voltage drop at a modulation frequency across the third and fourth PBG metamaterial regions is in the range of approximately 5% to less than approximately 50% of the voltage applied between the third and fourth electrodes.

19. The EO intensity modulator of claim 17, wherein the comparatively high εᵣ is in a range of approximately 50 to approximately 10¹.

20. The EO intensity modulator of claim 17, wherein the comparatively low εᵣ is in a range of approximately 1 to approximately 10.
